(19) United States
(12) Patent Application Publication
(10) Pub. No.: US 2026/0330742 A1
(43) Pub. Date: Oct. 22, 2026

(54) A METHOD OF CREATING VIRTUAL TEXTURE

(71) Applicant: EDWARDS CHESHIRE COMPANY LIMITED, Warrington (GB)

(72) Inventor: Robert WALSH, Warrington (GB)

(21) Appl. No.: 19/137,079

(22) PCT Filed: Nov. 14, 2023
(86) PCT No.: PCT/GB2023/052980

§ 371 Date: Jun. 9, 2025

(30) Foreign Application Priority Data
Nov. 14, 2022 (GB) 2216985.8

(51) Int. Cl. G06T 15/04; A63F 13/52; E04F 15/08; E04F 15/10

(52) U.S. Cl. CPC G06T 15/04; A63F 13/52; E04F 15/082; E04F 15/10; G06T 2210/04

(57) ABSTRACT

There is disclosed a method of providing virtual texture on a two-dimensional (2D) surface. The method comprises the creation of a master including a master surface. The master surface is physically altered in such a way so as to create the illusion of three-dimensional (3D) texture in the 2D surface created from the master surface. The master surface may be created from an existing model surface. The master surface may be modified so as to exaggerate existing features of the model surface. There is also disclosed a master comprising a master surface which has been created in such a way so as to create virtual texture on a 2D image of said master surface.

### TECHNICAL FIELD

The present application relates to a method of producing virtual texture and, also, reproducing said virtual texture on a substrate having a 2D surface.

More particularly, the application relates to a method of creating virtual texture on a 2D surface, which may be, for example, a flooring element, or, alternatively, a virtual 2D surface for virtual reality and/or gaming applications.

With ‘virtual texture’ we mean herein the illusion of the presence of depth (or other three-dimensional features) on an otherwise essentially 2D surface. The methods described herein are, in particular, well suited to providing the illusion of the discontinuities that normally exist between different parts or components, such as tiles or planks, in the case, for example, of conventional flooring, such as wooden flooring or heritage floors.

The present application also relates to a master for acquiring images to provide virtual texture on a 2D surface.

More particularly, the present application relates to a master which, when imaged using a camera, provides an image having virtual texture which may be used to create the illusion of physical texture on the 2D surface.

The present application also relates to a floor, wherein the floor comprises a plurality of said physical substrates having 2D surfaces.

More particularly, the present application relates to a floor, comprising an array of such substrates exhibiting virtual texture.

When a plurality of substrates exhibiting virtual texture creates a larger surface, the present application further provides a method of creating seamless virtual texture particularly at the joints between the 2D surfaces of the substrates, such that said joints are hardly noticeable to the eye.

Also, when a flooring to be replicated using the methods described herein is made of multiple components, such as ceramic or stone tiles, or wood planks, the present application provides a method of accurately replicating on a 2D image the visual feel of the discontinuities between such ceramic tiles or wood planks. In this way, the eye is tricked to read, in the replicated surface, the replicated discontinuities between the multiple components, rather than those that will inevitably exist between said 2D surfaces.

### BACKGROUND

There are two main categories for modern surface materials: natural and man-made.

A natural material surface will commonly use the natural characteristics of the material, combined with production processes, to create a design. For example, the existing texture of the natural material may be amplified to create the texture of the design. Similarly, the tone of the natural material may be altered or processed to create the desired tone of the final design. Examples of natural materials commonly used in construction are wood and stone. The use of natural materials, particularly in a home environment, is popular in part due to the warmth and character of the material. These aspects are often a result of variation in tone throughout the material, as well as a wide range of unique features such as knots and grain patterns. One of the desirable aspects of this type of surface is that in maintaining the natural characteristics of the material, each surface is unique.

Alternatively, man-made surfaces use synthetic raw materials which are either a blend of natural minerals or man-made compounds. Man-made materials are advantageous due to the material often being readily available. Further, man-made materials tend to be more hardwearing and often easier to maintain than common natural materials. For example, they do not require sanding and oiling such as required by wooden worktops or floors. Similarly, it is more straightforward to carry out a sympathetic replacement of a damaged area of man-made materials than, for example, a stone or wooden surface where a spot repair would be more obvious.

It is therefore desirable to create a material which captures the warmth and character of natural materials while maintaining the long-wearing and low maintenance advantages of man-made materials. There have been several attempts to provide this solution, some of these are described below.

Commonly, where man-made materials are used, a surface is produced with an aim of mimicking or recreating the tones and textures of natural materials. One such method involves capturing high definition images of the desired natural surface, such as wood or stone, and printing the images on to a man-made material to create the end product. This enables the end user to select cheaper materials, such as laminate, which attempt to visually resemble higher value materials such as wood, quartz or marble. The end product lacks the texture, and therefore the warmth and emotion, of the natural material. Further, due to the nature of the application of these materials, such as flooring or worktops, it is often necessary to arrange an array of smaller surfaces to create the larger desired surface. The larger surface therefore has several edges where the smaller surfaces join, for example between tiles or rolls of material. Due to the manufacturing capabilities and demands, a larger surface is often created using several repetitions of the same surface, to the extent that the repetition is visually obvious. The level of repetition necessary to create the larger surface combined with the obvious physical joints, which are out of place with the natural material to be recreated, contributes to the product being easily distinguishable from the natural material which it is attempting to mimic.

Another method which attempts to recreate the physical texture of natural materials on man-made materials is Registered Embossing. Registered Embossing involves printing a design on a material and overlaying a texture that aligns with the printed design. The texture is usually embossed into the product using a colander. The resultant embossment is shallow, and easily distinguishable from the natural material. This technique is often used, for example, to recreate the grain pattern of a wooden surface on a man-made material. However, similarly to the method described previously, Registered Embossing generally results in several smaller surfaces which are repeated and joined together to create a larger surface. Due to the effort required to develop a single design, and the requirement for mass production, the end product is a large surface which, again, has a high level of repetition in the surface. Further, the end product comprises several edges and joins which would not be present in a similar surface of the natural material. The result is a product which is without the texture and character of, and easily distinguishable from, the natural material which it is attempting to recreate.

A further method which attempts to recreate the physical texture of natural materials within man-made materials is the use of lacquer coatings. Similarly to Registered Embossing, this method seeks to create real physical texture in the surface of a man-made material. A layer of lacquer is laid and, while the lacquer is still wet, a texture is created, for example using a roller, in the lacquer. The wet lacquer is allowed to harden, with the texture remaining in place. However, similar to Registered Embossing, the result is texture which is very shallow and thus does not create a realistic solution.

The present invention seeks to overcome one or more of the limitations associated with the prior art.

### STATEMENT OF INVENTION

The present application sets forth an inventive solution to the problem of how to create a 3D impression on a 2D, or essentially 2D, substrate, that is a substrate having a 2D surface. Conversely to the process of Registered Embossing described above, the present application discloses a method, and resultant products, which provide a realistic imitation of a desired natural surface using only 2D materials and visual effects. The nature of these effects is such that, unlike the previous method of photographing a surface and printing it onto a substrate, the illusion of texture is created in the end product. It is well known that the human eye interprets shadows on a surface to determine depth and texture. The present application uses this knowledge to create the illusion of texture, for example the texture found in a natural surface, by creating a 2D image which is interpreted by the human eye as a textured 3D surface. In doing so, the present application discloses a method, and resultant products, which may provide the benefits of man-made materials while maintaining the desirable visual characteristics of the natural surface.

A further advantage disclosed by the present application is that due to the method of production, several unique smaller surfaces can be created to form a larger surface area which has little repetition within, further evoking the illusion of a real natural product while maintaining suitability for mass production.

As mentioned above, the methods of photographing natural surfaces, Registered Embossing, and similar, are generally limited by the level of repetition necessary to create a large surface while maintaining mass production. The end product of these methods is generally a surface comprising a series of smaller surfaces joined together. The edges between the surfaces are dissimilar to the natural boundaries seen in the natural surface and therefore further highlight that the larger surface is made from a replica of, rather than the actual, natural material. Where the larger surface comprises joints between smaller surfaces, the present application discloses employing methods to create the illusion of 3D texture of actual joints which, to the human eye, resemble the boundaries and joints of the natural surface. For example, where the surface to be recreated is a series of wooden panels, the individual smaller surfaces are produced with a 2D image such that the joints between the smaller surfaces are reminiscent of the joints between the real wooden panels.

The human eye recognises depth and texture through the interpretation of shadows on a surface. The present application discloses exploiting this understanding to create the illusion of 3D texture on a 2D substrate, herein referred to as ‘virtual texture’.

To create the virtual texture, it is necessary to first create a ‘master’ which will have a master surface. The master and master surface will usually be created from a surface to be replicated, herein referred to as a ‘model surface’. The model surface may comprise a natural material, such as wood or stone. Alternatively, the master and its master surface may be created as a new surface with virtual texture. The master surface is then captured in an image, taken for example by a conventional high-definition (HD) camera. The image capture of the master surface is then visually compared to the master or the model surface. It is this comparison that informs any alterations to the master that may be required. This process may be repeated a plurality of times with the master being recaptured after each iteration. The resultant image capture can then be printed onto a substrate, thus creating the final product.

In order to create virtual texture in the final product, physical texture is often not only created, but also exaggerated, in the master surface. For example, if the model surface contains a variety of physical, 3D features, such as: rounded edges; holes left from removed nails; paint marks; bruising; other types of marks on the surface; elevated grain; weathered grain; open joints between components; and, misaligned joints, as examples-these features may be exaggerated in the master. These features may be exaggerated through a plurality of techniques such as offsetting components of the master from one another or adding depth to pre-existing holes and ridges. Similar techniques can also be employed to add further features to the master to reach a desired design. The end result is a printed substrate which has the advantages of a man-made material while having the appearance of a natural material.

Individual components forming a master may be rearranged a plurality of times, with each arrangement resulting in a different image, and therefore a different individual printed substrate. The individual printed substrates may then be arranged to form a larger surface, one with a very low level of repeatability when compared to existing practices. For example, a surface with no repetitions up to 30 m² is easily achievable through the rearranging of the individual components forming just one master and master surface.

If the created printed substrates are to be arranged in such a way so as to form a larger surface, it is important to consider the joints between the individual surfaces. As mentioned previously, unnatural appearing joints are a key aspect in which existing techniques are suboptimal. In using the techniques described herein to create virtual texture within individual printed surfaces, the master may be manufactured so as to create virtual texture which simulates the physical joints of the model surface.

Further, the method of this application may also be applied to create realistic surfaces in virtual reality and gaming environments.

### DRAWINGS

Illustrative implementations will now be described, by way of example, with reference to the drawings.

In the drawings:

FIG. 1 shows a master created from a pre-existing model surface to be replicated.

FIG. 2 shows two patterns according to which a model surface and/or a master may be arranged.

FIG. 3 shows a further master, not created from a model surface but as a new surface.

FIG. 4 shows the master of FIG. 1, alongside a printed image of that master.

FIG. 5 shows a printed substrate with virtual texture next to the model surface which the printed substrate is replicating.

FIG. 6 shows an array of printed substrates with virtual texture.

FIG. 7 shows a split-level master.

FIG. 8 shows a floor created from an array of printed substrates with virtual texture as described herein.

FIG. 9 is a flowchart of a process for creating a new floor across a large surface area using the method of creating virtual texture, as described in the application.

Throughout the description and the drawings, like reference numerals refer to like features.

### DETAILED DESCRIPTION

The following provides a detailed description of a method of producing virtual texture on a two-dimensional (2D) image and, optionally, applying, for example by printing, the virtual texture onto a substrate. In this context, ‘virtual texture’ is intended to mean the illusion of three-dimensional (3D) features on the 2D image. The 2D image may optionally be reproduced onto a physical substrate to create a physical surface. Alternatively, the 2D image may be reproduced as a digital surface. The digital surface, for example, may be installed in a virtual reality or gaming environment.

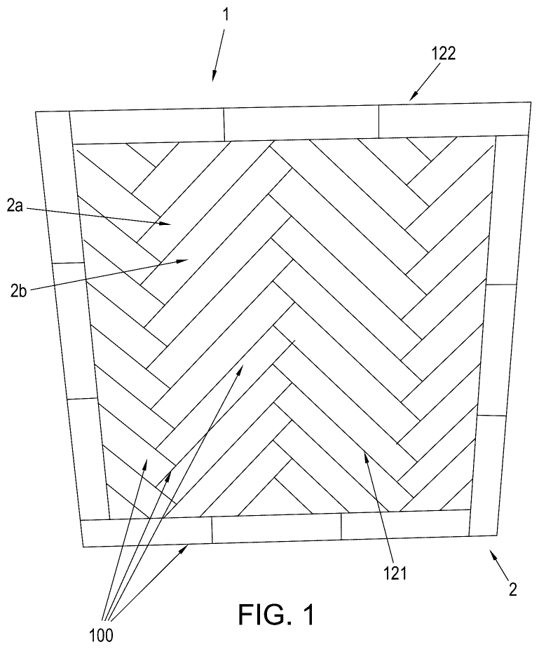

FIG. 1 shows a master 1 comprising a master surface 4. The design of the master surface 4 is informed by an existing surface which is to be replicated, herein referred to as a ‘model surface’ M. The model surface M may, optionally, comprise a natural material such as wood or stone. The model surface M will usually comprise a plurality of physical, 3D features such as, for example, rounded edges, holes left from removed nails, paint marks, bruising and marks on the surface, elevated grain, weathered grain, open joints between components, misaligned joints, etc. These features may, optionally, either alone or in combination, be recreated on the master surface 4, and/or portions of the surface to be replicated can be used directly in the master.

The human eye infers texture through the interpretation of light and shadow on a surface. The present application discloses this concept and applies this to create 3D characteristics 100 on the master surface 1 to replicate or augment the physical features on the model surface M. These 3D characteristics 100 on the master surface 4, which correspond to the physical features on the model surface M, when viewed as a 2D image 5, create the illusion of texture. The 2D image 5 may, optionally, be reproduced on a physical substrate 6. The texture of the physical substrate 6 is purely virtual and no physical alterations are made to the substrate 6 to create physical texture.

The master surface 4 may, therefore, comprise exaggerations of the existing features of the model surface M. For example, where the model surface M comprises holes and dents, the depths of these features may be increased to exaggerate the level of shadow which they create. Optionally, additional features which were not pre-existing in the model surface M may be introduced on the master surface 4 and will therefore be present on the 2D image 5 and any related physical substrate 6.

The illustrated master 1 comprises a series of individual components 2 (more particularly, 2a, 2b, etc.) as seen in FIG. 1. The individual components 2 may, for example, be panels, tiles or bricks. The individual components 2 may, optionally, be rearranged, to create a plurality of master surface designs from the same components 2a, 2b. Further, the individual components 2 may comprise a plurality of tones, markings and patterns which are thus recreated on the master surface 4. These features may, optionally, be exaggerated or muted on the master surface 4 in order to achieve the desired effect in the 2D image 5. For example, with reference to the master 1 of FIG. 1, the tone of a first panel 2b may be darkened within the master surface 4 while the tone of a second panel 2a may be lightened within the master surface 4 to maintain the level of contrast of the model surface M in the 2D image 5 of said master surface 1.

In one implementation, the model surface M is of historical or sentimental importance. For example, the model surface M may be an existing floor or wall which is, or was previously, installed in a historic building or residential property. In particular, where the surface of an existing building is to be preserved, the present application provides a method whereby a visually similar floor is produced. Alternatively, wherein the flooring is to be removed, either partially or entirely, the present application provides a method of producing a sympathetic replacement.

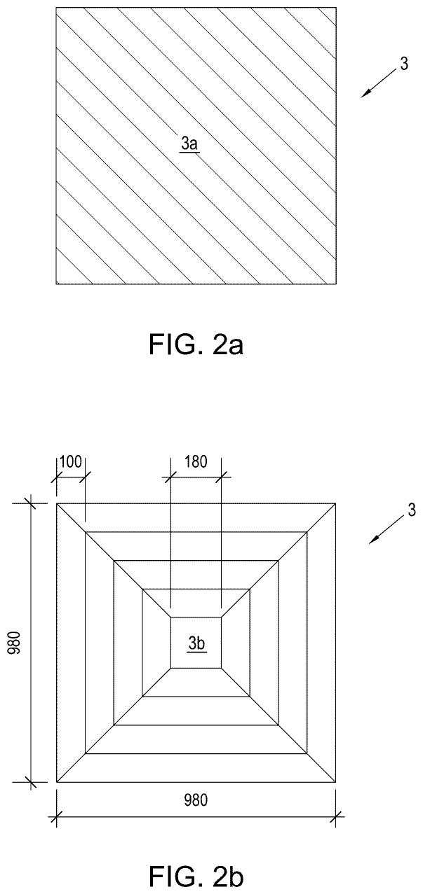

FIGS. 2a and 2b each show an example of a pattern 3 which the components 2 of the master 1 may be arranged to form. It will be understood that there is a wide range of patterns 3 available and that any patterns 3 shown in this application are merely examples. The same master 1 may, optionally, be arranged to form multiple designs. ‘Design’ refers to a single arrangement of the components 2, with given 3D characteristics 100. Optionally, the components 2 of the master 1 may be arranged to form several designs having the same pattern 3. For example, the model surface M and the master 1 may comprise a series of panels, and the panels may be arranged in a first pattern 3a and the panels then rearranged to still conform to the same pattern 3a but with the panels arranged in different positions to form a further design. Also, the 3D characteristics can be modified to change the design, while keeping the same pattern 3.

The components 2 of the master 1 may also be arranged to form alternative patterns 3. For example, the components 2 may be arranged in a first pattern 3a and then rearranged to be in a second pattern 3b, or any further pattern 3 thereafter. As mentioned previously, a limitation of existing technologies is the level of repetition of a single design when creating a larger surface, for example a floor 9. In rearranging the same components 2 to form a plurality of designs having the same pattern 3, it is possible to produce a surface with a large surface area, such as a floor 9, with a comparatively low level of design repetition.

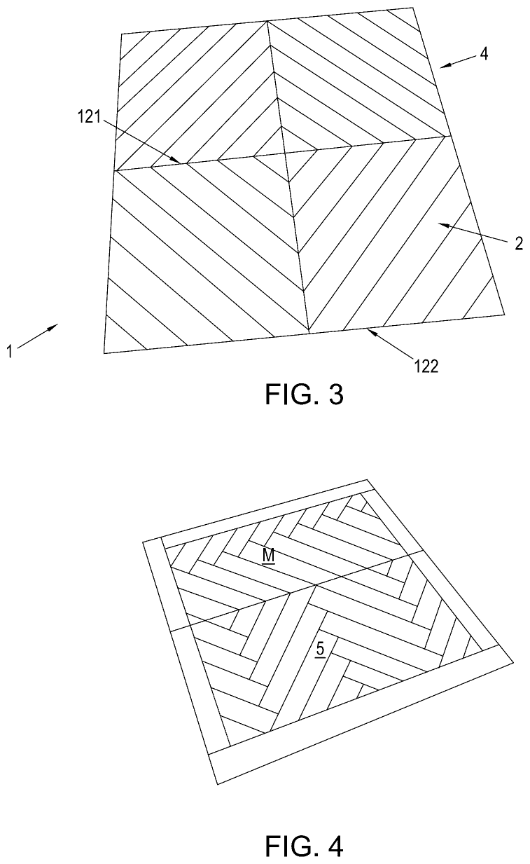

FIG. 3 shows a further example of a master 1, with its master surface 4. Conversely to the example master surface 4 previously discussed, the master surface 4 was not created with the aim of replicating an existing model surface M. The master surface 4 is instead created from newly manufactured components 2 (in this case wooden planks) and it will be used to create a new 2D substrate 6, with virtual texture. The techniques applied to the previously described master 1, that is the one which was a replica of a model surface M, may also be applied to this new master 1.

Where the master surface 4 comprises a plurality of components 2, an example of one technique to create virtual texture is the introduction, modification or exaggeration of gaps between the components 2 of the master surface 4. The gaps are introduced (modified or exaggerated) so as to create additional shadow on the master surface 4. As discussed previously, the human eye reads texture from light and shadow, the introduced gaps thus serve to create virtual texture in a related 2D image 5 of the master surface 4 that will be later captured. Virtual texture may be further created within the 2D image 5 by arranging the components 2 of the master surface 4 at a plurality of heights (see for example FIG. 7 below), creating additional shadow on the master surface 4. The edges 121 of the individual components 2 of the master 1 may also be rounded or distressed, again altering their shadows on the master surface 4.

As mentioned previously, the surface features of a model surface M may be incorporated onto a master surface 4. However, where no model surface M is considered, surface features may still be introduced onto the master surface 4. Such features 100 may be created from tools that include nails, such as nail holes, paint, such as paint marks, or other tools to create superficial surface damage, cracks and splits. These features may, optionally, be exaggerated in the master surface 4 to create the appearance of the desired texture in the corresponding 2D image 5. It should be understood that any of the techniques described herein to create virtual texture may be applied interchangeably to a master surface 1 created from an existing model surface M that the master 1 seeks to replicate, and to a master surface 4 not created from a model surface M, but from new.

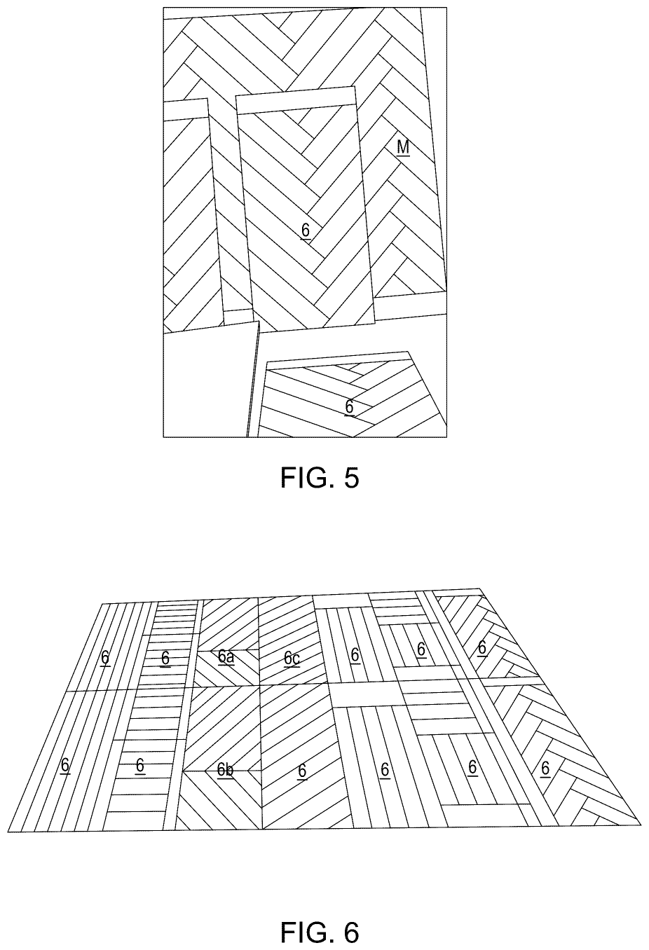

FIG. 4 shows a 2D image 5 of a master surface 4 next to a model surface M, which informed the creation of the master 1. The 2D image 5 of the master surface 4 is created by photographing the master 1. The master surface 1 may be captured in controlled conditions which, for example, may be a well-lit, humidity and temperature-controlled environment. As discussed above, the 2D image 5 of the master surface 4 may be compared to the model surface M, or alternatively to the master 1. This comparison may inform any changes to the master surface 4 to obtain virtual texture in the 2D image 5 which is better representative of the model M, or otherwise desired, surface. The master surface 4 may, optionally, be altered and recaptured a plurality of times until the desired virtual texture is obtained. For example, the master surface 4 may be altered to create further regions of shadow in order to create an optimal 2D representation of the model surface M.

In one implementation, additional features 100 not present in the model surface M are added to the master surface 4 to create virtual texture in the 2D image 5. This process is, optionally, repeated for a plurality of master surfaces 4 generated from a plurality of designs of the model surface M. The resultant plurality of 2D images 5 of the master surface 5 will thus possess the required virtual texture; the generated images 5 may be reproduced on corresponding physical substrates 6.

The comparison of the 2D image 5 with the master surface 4 and/or the model surface M is a key part of the process of creating realistic virtual texture in the end product. In order to create realistic virtual texture, it is important to create balance within the end product. If the features 100 are over exaggerated, for example, the end product may appear artificial. If the features 100 are understated, they may appear 2D and unrealistic in the end product. In carrying out the comparison and adapting the master surface 1 accordingly, an optimal end product can be created.

FIG. 5 shows a physical substrate 6 next to the corresponding master surface 1. The master surface 4 has been created in such a way so that the 2D image 5 of the master surface 1 provides the illusion of the physical texture of the model surface M. The 2D image 5 is reproduced on the physical substrate 6. The texture of the physical substrate 6 is purely created by optical illusion, the physical texture of the model surface is not recreated on the physical substrate 6 through physical means. The physical substrate 6 is, optionally, a man-made material such as vinyl or laminate. The resultant physical substrate 6 exhibits virtual texture corresponding to the 3D texture of the model surface, and any additional features 100 incorporated on to the master surface 4. Advantageously, the physical substrate also maintains the valuable physical properties of the material from which it was manufactured, such as for example, vinyl or laminate.

The physical substrate 6 may include areas of light and shadow, in accordance with the alterations made to the master surface 1, which when viewed with the human eye appear as 3D texture. The physical substrate 6 may, therefore, be more visually similar to the model surface, rather than the master surface 1 from which the 2D image 5, reproduced on the physical substrate 6, was created.

Existing processes attempt to recreate the texture of, for example, natural surfaces such as wood and stone through the creation of physical texture on a physical substrate. The texture created is of a shallow depth and, due to the requirements for mass manufacture, has a high level of repetition when an array of smaller surfaces are arranged to form a larger surface. Further, the physical texture manufactured by these techniques may lead to physical texture which is easily damaged or difficult to maintain. Advantageously, the present application discloses a method of creating texture which is purely visual. The end product of the method described herein is both more realistic and more easily maintained than the product of the existing technologies. The master surface 1 may also be rearranged so that a plurality of 2D images 5 may be reproduced on individual physical substrates 6 following the process described herein. Optionally, several physical substrates 6 are created from the same master surface 1. The master surface 1 may, optionally, be rearranged to form a plurality of designs and/or patterns 3 which are then used to create a plurality of physical substrates 6 as described above. The method described by the present application is therefore able to create a product with a lower level of repetition when compared with existing techniques.

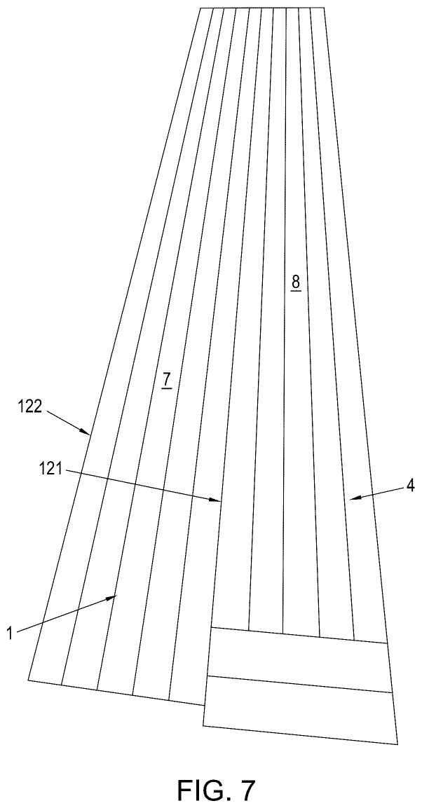

FIG. 6 shows an array of physical substrates 6, each with a 2D image 5 reproduced on their surface, creating virtual texture. A first substrate 6a and a second substrate 6b exemplify two individual designs created from the same master surface 1 in the same pattern 3. A third substrate 6c exemplifies the rearranging of the same components 2 of the master surface 1 to create a substrate 6c of a different pattern 3 when compared with the first substrate 6a or the second substrate 6b.

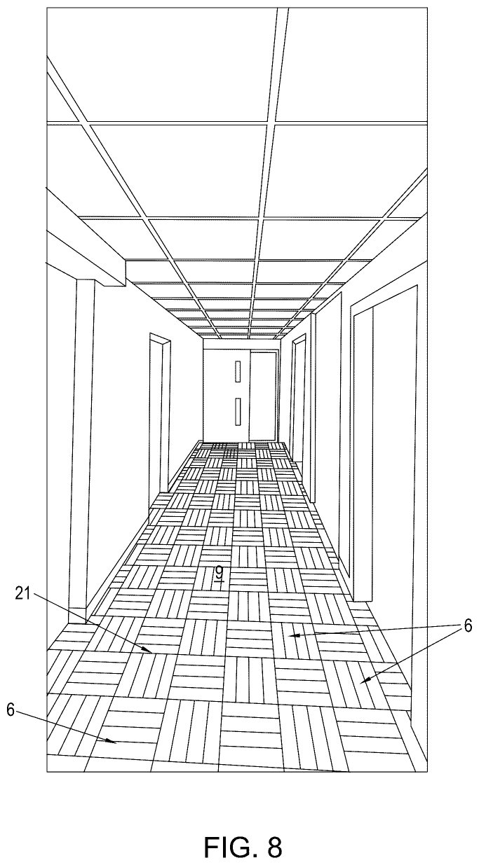

The array of substrates 6 may be arranged to form a larger surface 9, such as a floor or wall. The larger surface 9 will have a level of repetition which corresponds to the number of individual designs obtained from the master surface 1. For example, up to 30 m² of surface may be created without any visual repetition through the creation of multiple designs of the master surfaces. The low level of repetition in the larger surface 9 is key to creating the desired imitation of the model surface. Wherein a natural surface is to be recreated, a key difference which makes a man-made surface created using existing technologies distinguishable from a natural material surface, is the level of variation. For example, in a wooden floor the individual panels are unique in terms of the combination of grain pattern, colour, tone, dents, holes, ridges and other features. Existing techniques attempt to create this, using methods such as high definition photography or Registered Embossing, as described herein in the Background section. Due to the requirements for mass production, the product of these methods is a small amount of individual designs which are required to be repeated a plurality of times to create a larger surface area. Conversely, the present application describes a method which creates a larger number of designs and therefore requires less, or no, repetition of each design to create a surface 9 of comparable area. The existing techniques therefore create a surface which is easily distinguishable from the desired natural surface. The method described herein, instead creates a surface 9 which is less distinguishable from the natural surface at least due to a comparatively low level of repetition.

Where the individual physical substrates 6 are arranged to form a larger surface 9 (as shown in FIG. 8, discussed in more detail below), there will be physical joints 21 between the individual physical substrates 6. Further, where the model surface comprises a series of components, the physical joints between the components of the model surface are replicated within the 2D image 5 through the creation of virtual texture. Similarly, virtual texture may also be created at the physical joints 21 between the physical substrates 6 of the larger surface 9. The virtual texture created may replicate the physical joints between the components of the model surface. The edges 122 of the master surface 4 may therefore be arranged and then modified in such a way so as to create virtual texture representative of the physical texture of the physical joints 21 between different substrates of the desired surface.

FIG. 7 shows a master surface 4 wherein the master surface 4 is split into two levels 7, 8. Additional areas of shadow are therefore created at the edge between the two levels 7, 8. The upper level 8 is arranged so as to create additional shadow on the lower level 7. Alternatively, the gaps 121 between the components 2 may be exaggerated to create additional light and or shadow on the master surface 4. Accordingly, virtual texture may be created on a 2D image 5 created from this master surface 4. In particular, the virtual texture may be created at the edge 21 of a plurality of physical substrates 6. The virtual texture may be created such that when the plurality of physical substrates 6 are aligned with one another, the physical joints 21 between the physical substrates 6 is visually similar to the physical joint within the model surface. The physical joint between substrates 6 may therefore be visually similar to the virtual texture joints created internally within the 2D image 5. This is a further advantage of the present method over existing technologies which create visibly obvious lines and joints between smaller surfaces within a larger surface.

In particular, when used to recreate a surface comprising a natural material it is advantageous to recreate any joints present in the natural material. For example, when the natural material comprises a series of wooden panels, it is advantageous for the larger surface to appear as though it is made up of individual wooden panels, as opposed to smaller areas of substrates or vinyl tiles. The present application therefore proposes a method which creates a replica surface which more closely resembles the original natural surface. Further, in creating joints 21 between the substrates 6 which are visibly similar to the illusion of joints internal to the 2D image 5 reproduced upon the physical substrate 6, the physical joints 21 are less distinguishable from the illusion of joints created through virtual texture. Making the physical joints less 21 distinguishable creates a more realistic illusion of the surface being created from natural materials.

FIG. 8 shows a larger surface 9 which comprises an array of individual substrates 6 created using the method described herein. The larger surface 9 is installed as a floor. The individual substrates 6 have been created from a plurality of designs obtained from the same master surface 1, trying to replicate the same model surface M. By comprising a plurality of designs, the floor 9 shown in FIG. 6 has no visible repetitions. That is, although the same wooden panels feature in all the images 5, recreated on the physical substrates 6, they have been arranged in a unique design for the creation of each image 5. Further, virtual texture has been used to disguise the physical joints 21 between individual physical substrates 6 which are thus visually similar to the joints 121 between the individual wooden panels within the master 1 (and, therefore, also within the model surface M).

It is important to note that the method described herein is applicable to recreating a wide range of surfaces such as floors, walls and textiles. Further, the process can be applied to replicate a variety of materials which include stone, brick and wood.

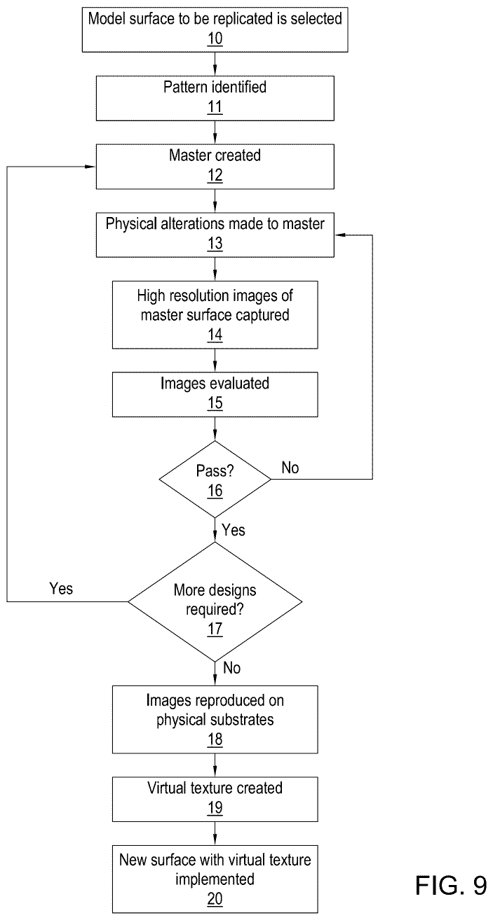

With reference, finally, to FIG. 9 there are illustrated methods of creating a surface with virtual texture comprising a plurality of smaller surfaces. This process can also be applied to a master surface 4 which is designed to create a new surface. The model surface which is to be replicated through the application of this method is selected 10. The model surface may, for example, be an existing surface of a natural material. The model surface may also hold a historical or sentimental value. Further, the model surface may be a component of a larger surface which requires repair or replacement. A plurality of components 2 are arranged 11 to form a specific pattern. For example, wherein the model surface is an arrangement of wooden panels, the wooden panels are arranged according to the same pattern 3. A master 1 is created 12. The master surface 4 has therefore been informed by the initial choice of model surface. The master surface 1 is then altered 13 using physical techniques to create a surface which, when replicated in 2D, will create virtual texture representative of the physical texture of the model surface. The human eye detects texture through areas of shadow and light on a surface. The master surface 4 is altered and modified 13 to create the illusion of texture in a 2D image 5 through the creation of light and shadow. The master surface 4 may be altered 13 further, to create areas of light and shadow which better create the illusion of the physical features of the model surface in the 2D image 5.

For example, where the model surface includes joints, dents, nail holes, ridges or the like, the master surface 4 may be altered 13 so as to recreate these 100 in the form of virtual texture within the resultant 2D image 5, and the corresponding physical substrate 6. The master surface 1 is altered 13 such that a 2D image 5 of the master surface 1 will be visually similar to the model surface. The master surface 1 is therefore visually different to both the model surface and the physical substrate 6 comprising the virtual texture. For example, in the case of natural materials such as wood, there are variations to tone and grain as well as unique dents, scuffs and ridges which are not accurately represented by taking an image of the model surface M. The master surface 1 may be altered 13 to exaggerate existing physical features of the model surface M so as to create areas of shadow and light which, when photo-captured and viewed in a 2D environment, are interpreted by the human eye as physical texture.

Following the completion of alterations to the master surface 1 a 2D image 5 of the master surface 4 is captured 14; the 2D image 5 is then compared 15 to the model surface, or optionally to the master surface 4 itself. The comparison may result in additional alterations to the master surface 1. The master surface 1 may require several iterations to achieve a realistic result. Balancing 16 of the features within the end product is key for producing a surface which is realistic.

The comparison of the 2D image 5 of the master surface 1 with the model surface, or alternatively the master surface 1, is important in producing an optimal product. For example, where the features of a model surface such as nail holes and dents are over-exaggerated the end result may appear artificial. Similarly, wherein the features are understated, they may appear 2D and unrealistic. Optionally, this process is repeated 17 for additional designs. For example, wherein a plurality of surfaces are required, the master surface 1 may be arranged to form a plurality of designs. The model surface may comprise a series of wooden panels. The wooden panels may be arranged multiple times in the same pattern 3 or in different patterns 3a, 3b to create a variety of designs which are to be recreated as a surface with virtual texture. The master surface 4 is rearranged in each of these designs and the processes of making any necessary alterations 13 and capturing 14 the master surface 4 are carried out. The resultant 2D images 5 are, optionally, reproduced onto a physical substrate 6. The physical substrate 6 is, optionally, the same dimensions (i. e length and breadth) as the master 1.

Where it is desired that a plurality of physical substrates 6 with virtual texture are arranged to form a larger surface 9, there will be joints 21 present between the individual physical substrates 6. The master surface 4 may be altered 13 using the techniques described above to create areas of light and shadow at the edges of the physical substrates 6 so as to replicate the physical joints of the model surface. For example, where the model surface is an array of wooden panels, the master 1 is created such that the physical joints 21 between the substrates 6 are visibly similar to the joints between the wooden panels of the model surface. The joints between the physical substrates 6 may therefore also be visibly similar to the illusion of joints internal to the physical substrate 6 created through virtual texture only.

The 2D images 5 of the master surface 1 are reproduced onto individual physical substrates 6 to create 18 replica physical surfaces. The physical substrates 6 may be a man-made material such as vinyl, laminate or ceramic tiles. The individual components 2 of the master surface 1 can be rearranged 17 to form a further design. The design may optionally be optimised to minimise repeatability. The design may also be arranged to optimise the positions of the components 2 so that adjacent edges of the individual physical substrates 6 create the illusion of a continuous surface. A large surface 9 with low repeatability and virtual texture similar to the physical texture of the model surface is therefore created 20.

In one implementation, the process of creating virtual texture is applied to the creation of flooring. For example, an existing floor comprising a series of wooden panels may inform the creation of a master surface 1. The master surface 1 may then be modified 13 to exaggerate dents, nail holes 100 and/or to amplify the areas of shadow caused by the physical joints 121 between the wooden panels. The master surface 1 may then be photo-captured 14. The wooden panels may then be rearranged 17 to form several additional designs, and resultant 2D images 5 which are complimentary to one another. The 2D images 5 may be reproduced 18 on to individual physical substrates 6 which may then be arranged 19 to create 20 a floor which is visually similar to the original flooring. Further, the process of applying additional shadow and/or light at the edges 122 of the master surface 1 may be applied to replicate the joints 121 between the wooden panels at the joints 21 between the individual physical substrates 6.

The individual physical substrates 6 may, optionally, be used to replace a flooring which is damaged and in need of repair, or to recreate a visibly similar floor at a different location. For example, if the floor or walls of a historical building are being removed, they may be replicated using this process. Further, the 2D image 5 created from the master surface 1 may also be reproduced 18 on a variety of surfaces, for example textiles or paper. The 2D image 5 may also be applied to create 2D surfaces for use in virtual reality simulations or gaming environments.

In a further implementation, the above process is applied to create realistic surfaces in virtual environments such as in gaming or virtual reality applications. As gaming and technology improves, as do the expectations of the user for a visibly realistic gaming environment. The process of creating virtual texture described herein may be applied to a gaming environment. For example, where a gaming environment requires a brick or tiled area, a master surface 1 may be created from a model surface comprising bricks or tiles. The master surface 1 may therefore be altered, increasing the number of areas, or amount, of light and shadow on the master surface 1 to create virtual texture on an 2D image 5 of the master surface 1 which may then be applied to the gaming environment. Similarly, virtual texture at the joints between 2D images 5 within virtual environments may be created using the processes described herein. When a virtual reality environment is required, the surfaces of the environment can be created through applying the process of this invention to create realistic environments.

The singular terms “a” and “an” should not be taken to mean “one and only one”. Rather, they should be taken to mean “at least one” or “one or more” unless stated otherwise.

The word “comprising” and its derivatives including “comprises” and “comprise” include each of the stated features but does not exclude the inclusion of one or more further features.

The above implementations have been described by way of example only, and the described implementations are to be considered in all respects only as illustrative and not restrictive. It will be appreciated that variations of the described implementations may be made without departing from the scope of the disclosure.

It will also be apparent that there are many variations that have not been described, but that fall within the scope of the appended claims.

### LIST OF REFERENCE NUMERALS USED IN THE DESCRIPTION AND DRAWINGS

M Model
1 Master (created from a model surface)
2 Component (of master)
3 Pattern
4 Master surface
5 2D Image
6 Physical substrate
7 Lower level of master surface
8 Upper level of master surface
9 Larger surface area (e.g. floor)
10 Selecting model surface
11 Identifying a pattern
12 Creating master
13 Physically altering master surface
14 Capturing high resolution images of master surface
15 Comparing images to model surface
16 Checking if (further) alterations are required to master
17 Checking if further designs are required
18 Reproducing images onto substrates
19 Creating virtual texture on substrates
20 Creating work product (large surface) with virtual texture
21 Joint (between substrates)
100 3D surface characteristics (of master)
121 Joint (between two master components)
122 Edge (of master)

1. A method of creating virtual texture on two-dimensional (2D) substrates, the method comprising:
providing a master (1), said master comprising a master surface having one or more three-dimensional (3D) surface characteristics;
modifying at least one of said 3D characteristics of the master surface;
capturing one or more 2D images of the master surface;
visually comparing at least one 2D image of the master surface with a model surface; and,
reproducing at least one selected captured 2D image onto a corresponding 2D substrate.

2. The method of claim 1, wherein the model surface is the master surface.

3. The method of claim 1, wherein the visual comparison of the at least one 2D image of the master surface with the model surface is carried out before the modification of the at least one of said 3D characteristics of the master surface.

4. The method of claim 3, wherein said modification is carried out on the basis of said visual comparison.

5. The method of claim 3, wherein said visual comparison and said modification are carried out multiple times, iteratively.

6. The method of claim 1, wherein said modifying at least one 3D characteristic of the master surface comprises at least one of:
(i) creating one or more 3D surface characteristics on the master surface which are exaggerations of corresponding one or more physical features present on the model surface;
(ii) exaggerating pre-existing 3D surface characteristics of the master surface and
(iii) introducing additional one or more 3D surface characteristics on the master surface.

7. The method of claim 1, wherein said 3D surface characteristics comprise at least one of:
(i) an edge, such as a rounded edge,
(ii) a hole, such as a nail hole
(iii) a mark, such as a paint mark,
(iv) a bruising,
(v) an elevated grain,
(vi) a weathered grain, and
(vii) a joint, such as an open joint, or a misaligned joint.

8. The method of claim 1, wherein the master comprises a plurality of components.

9. The method of claim 8, wherein the method further comprises arranging the components to form a predetermined pattern.

10. The method of claim 9, wherein the method further comprises arranging the components to from a plurality of designs, wherein each design is defined by the components arranged differently, in the same pattern.

11. The method of claim 1, wherein the method further comprises arranging a plurality of said 2D substrates to form a larger surface area, said larger surface area comprising joints between said 2D substrates.

12. The method of claim 11, wherein said larger surface area (9) comprises multiple designs obtained from the same master (1).

13. The method of claim 11, wherein modifying at least one 3D characteristic of the master surface is performed to create virtual texture to minimise or hide the joints defined between the plurality of 2D substrates.

14. The method of claim 7, wherein the components of the master are at least one of (i) arranged at a plurality of heights and (ii) arranged with predetermined gaps in between the components, particularly to create virtual texture at said joints between the plurality of 2D substrates or to create virtual texture replicating an edge or a joint between two components of the master.

15. The method of claim 1, wherein the 2D substrate is a physical substrate.

16. The method of claim 15, wherein the 2D substrate is a flooring tile or plank.

17. The method of claim 1 wherein the 2D substrate is virtual, for example is a wall-paper for videogaming applications.

18. A master for carrying out the method of claim 1, claim, the master comprising:
a plurality of components arranged to form a predetermined pattern the plurality of components defining a master surface having one or more 3D surface characteristics;
means for modifying a relative height or gap between said plurality of components, so as to create virtual texture on a 2D image captured from the master surface, particularly in correspondence of a joint formed between said 2D substrates or a joint formed between said components or an edge of the master.

19. The master of claim 18, wherein the components may be arranged to form a plurality of designs.

20. The master of claim 18, wherein the components are newly manufactured.

21. The master of claim 18, wherein the components are reused components.

22. A floor of man-made material comprising a plurality of 2D substrates, such as tiles or planks, wherein each 2D substrate comprises a virtual texture on an upper surface thereof, which virtual texture has been created using the method of claim

16.
